(19) United States
(12) Patent Application Publication
(10) Pub. No.: US 2019/0001834 A1
(43) Pub. Date: Jan. 3, 2019

(54) CHARGE/DISCHARGE APPARATUS

(71) Applicant: MITSUBISHI ELECTRIC CORPORATION, Tokyo (JP)

(72) Inventor: Takuto SUZUKI, Tokyo (JP)

(73) Assignee: MITSUBISHI ELECTRIC CORPORATION, Tokyo (JP)

(21) Appl. No.: 16/068,006

(22) PCT Filed: Mar. 1, 2016
(86) PCT No.: PCT/JP2016/056186

§ 371 Date: Jul. 3, 2018

(51) Int. Cl. B60L 11/18

(52) U.S. Cl. CPC B60L 11/1838; B60L 2210/30; B60L 11/1816

(57) ABSTRACT

A charge/discharge apparatus 200 includes a power conversion unit, which converts alternating-current power into direct-current power and supplies the direct-current power to a power supply source in an electric vehicle, and a control unit, which controls the power conversion unit, and performs transmission of information between the electric vehicle and the control unit. The control unit determines chargeability to the power supply source in the electric vehicle connected to the charge/discharge apparatus using compatibility information indicating that the charge/discharge apparatus is compatible with a charging method in accordance with characteristics of the power supply source, and non-compatibility information indicating that the charge/discharge apparatus 200 is not compatible with the charging method.

### FIELD

The present invention relates to a charge/discharge apparatus connected to a storage battery mounted on a motor vehicle.

### BACKGROUND

In recent years, with the spread of electric vehicles, use of power supplied from electric vehicles has attracted attention. In particular, a system which supplies power that is stored in a storage battery mounted on an electric vehicle to household electrical appliances is called Vehicle to Home (V2H), and the power supplied from the electric vehicle is expected as an emergency power supply at a time of a power failure, a power supply for cutting peak power usage, or a part of an energy management system linked with solar power generation. From the above, it is expected that the charge/discharge apparatus will be more and more popularized in homes or public facilities.

Patent Literature 1 discloses a technique for enabling charging/discharging of a storage battery mounted on an electric vehicle. The charge/discharge apparatus disclosed in Patent Literature 1 determines chargeability by communication between an electric vehicle and the charge/discharge apparatus, and when a user removes a connector from a Direct Current (DC) inlet, the charge/discharge apparatus prevents a terminal of the DC inlet to which a voltage of a storage battery is applied from being exposed.

### CITATION LIST

### Patent Literature

Patent Literature 1: Japanese Patent Application Laid-open No. 2015-96018

### SUMMARY

### Technical Problem

There are various types of storage batteries to be mounted on motor vehicles, examples thereof include a nickel-metal hydride storage battery, a lithium ion storage battery, and a lithium ion polymer storage battery. In some cases, a plurality of different types of storage batteries among these storage batteries is mounted on a motor vehicle. As described above, there are various types of storage batteries mounted on motor vehicles. Specifications of charge/discharge apparatuses vary depending on the type of a storage battery thereof, so it is necessary for a charge/discharge apparatus to determine whether the charge/discharge apparatus is compatible with a charging method in accordance with the characteristics of the storage battery.

When a storage battery mounted on a motor vehicle is charged with a charge/discharge apparatus which does not compatible with a charging method in accordance with characteristics of the storage battery, the performance of the charge/discharge apparatus or the storage battery deteriorates considerably rapidly, and an amount of power discharged from the storage battery and an amount of power charged to the storage battery decrease to be lower than a desired amount of power compared with a case of charging with a charge/discharge apparatus compatible with the storage battery.

Patent Literature 1 does not disclose a method for determining whether charging in accordance with characteristics of a storage battery is possible. Therefore, development of a charge/discharge apparatus has been desired which, even when a motor vehicle permits charging, determines whether a storage battery is chargeable.

The present invention has been made in view of the above, and an object thereof is to obtain a charge/discharge apparatus capable of suppressing deterioration of performance of a storage battery mounted on a motor vehicle.

### Solution to Problem

To solve the above problems and achieve an object, the charge/discharge apparatus according to the present invention includes a power conversion unit to convert alternating-current power into direct-current power and to supply the direct-current power to a secondary battery in a motor vehicle and a control unit to control the power conversion unit and to perform transmission of information between the motor vehicle and the control unit. The control unit determines chargeability to the secondary battery in the motor vehicle connected to the charge/discharge apparatus using compatibility information indicating that the charge/discharge apparatus is compatible with a charging method in accordance with characteristics of the secondary battery, and non-compatibility information indicating that the charge/discharge apparatus is not compatible with the charging method.

### Advantageous Effects of Invention

According to the present invention, it is possible to suppress deterioration of performance of a storage battery mounted on a motor vehicle.

### BRIEF DESCRIPTION OF DRAWINGS

FIG. 1 is a configuration diagram of a charge/discharge system using a charge/discharge apparatus according to an embodiment of the present invention.

FIG. 2 is a sequence chart illustrating operations of the charge/discharge apparatus according to the embodiment of the present invention and an electric vehicle.

FIG. 3 is a diagram illustrating an example of a battery identification table set in a control unit in the electric vehicle illustrated in FIG. 1.

FIG. 4 is a diagram illustrating an example of a charging method compatibility table set in a control unit in the charge/discharge apparatus illustrated in FIG. 1.

FIG. 5 is a diagram for explaining a process for determining chargeability based on the battery identification table illustrated in FIG. 3 and the charging method compatibility table illustrated in FIG. 4.

FIG. 6 is a flowchart of a chargeability determination process in S105 illustrated in FIG. 2.

FIG. 7 is a diagram illustrating an example of a power source identification table set in a control unit of a motor vehicle equipped with a power source such as a secondary battery, an internal combustion engine, or a fuel cell, instead of the electric vehicle illustrated in FIG. 1.

FIG. 8 is a diagram illustrating a modification of the charging method compatibility table set in the control unit in the charge/discharge apparatus illustrated in FIG. 1.

FIG. 9 is a diagram for explaining a process for determining chargeability based on the power source identification table illustrated in FIG. 7 and the charging method compatibility table illustrated in FIG. 8.

### DESCRIPTION OF EMBODIMENTS

Hereinafter, a charge/discharge apparatus according to an embodiment of the present invention will be described in detail with reference to the drawings. The invention is not limited to the embodiment.

### Embodiment

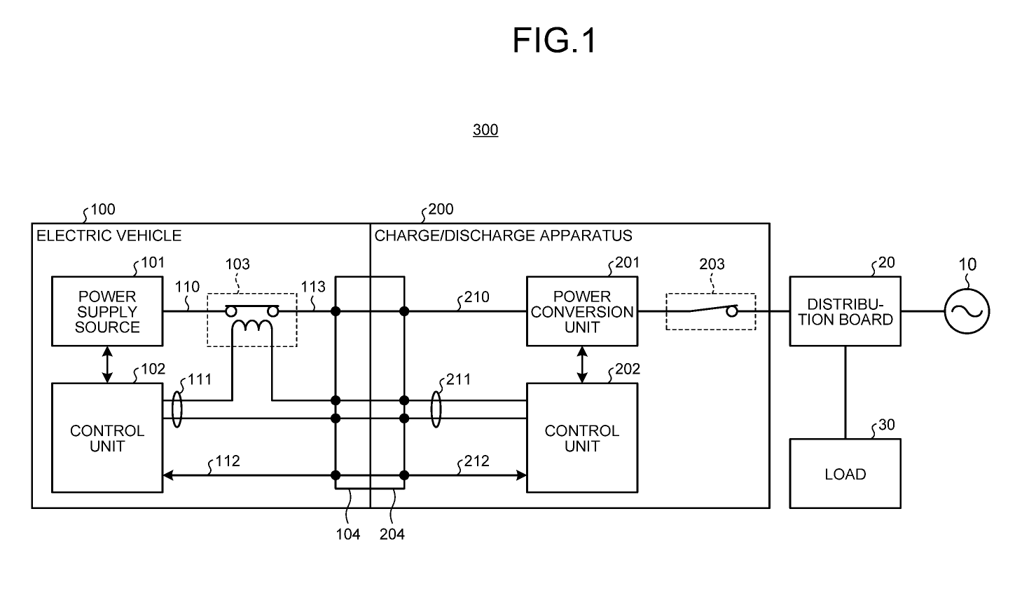

FIG. 1 is a configuration diagram of a charge/discharge system using a charge/discharge apparatus according to an embodiment of the present invention. The charge/discharge system 300 illustrated in FIG. 1 includes an electric vehicle 100 and the charge/discharge apparatus 200 connected to the electric vehicle 100. In the present embodiment, the charge/discharge system 300 using the electric vehicle 100 will be described. However, a motor vehicle applicable to the charge/discharge system 300 is not limited to the electric vehicle 100. Any motor vehicle may be used as long as a secondary battery chargeable by the charge/discharge apparatus 200 is mounted thereon as a power supply source 101, and a hybrid vehicle equipped with an internal combustion engine, a plug-in hybrid vehicle, or a range extender Electric Vehicle (EV) may be used.

The electric vehicle 100 includes the power supply source 101, a control unit 102, a conductor 103, and an inlet 104. The charge/discharge apparatus 200 includes a power conversion unit 201, a control unit 202, an interconnection switch 203, and a charge/discharge connector 204.

By the charge/discharge connector 204 connected to the inlet 104 of the electric vehicle 100, a power line 210 in the charge/discharge apparatus 200 is connected to a power line 113 in the electric vehicle 100, a signal line 211 in the charge/discharge apparatus 200 is connected to a signal line 111 in the electric vehicle 100, and a communication line 212 in the charge/discharge apparatus 200 is connected to a communication line 112 in the electric vehicle 100.

One ends of the power line 210, the signal line 211, and the communication line 212 are connected to the charge/discharge connector 204 of the charge/discharge apparatus 200. The other end of the power line 210 is connected to a direct-current end side of the power conversion unit 201, and the other ends of the signal line 211 and the communication line 212 are connected to the control unit 202. An alternating-current end side of the power conversion unit 201 is connected to a distribution board 20 via the interconnection switch 203. A load 30 and a power system 10 are connected to the distribution board 20. As the load 30, a household electrical appliance such as an air conditioner, a refrigerator, or a lighting device driven with alternating-current power can be exemplified.

One ends of the power line 113, the signal line 111, and the communication line 112 are connected to the inlet 104 of the electric vehicle 100. The conductor 103 is arranged between the power supply source 101 and the inlet 104, the other end of the power line 113 is connected to one end of the conductor 103, and one end of the power line 110 is connected to the other end of the conductor 103.

The other end of the power line 110 is connected to the power supply source 101, and the other ends of the signal line 111 and the communication line 112 are connected to the control unit 102.

The communication line 112 communicates information on charging/discharging of the power supply source 101 between the electric vehicle 100 and the charge/discharge apparatus 200, and as a communication scheme, a communication protocol of Controller Area Network (CAN) can be raised as an example.

The conductor 103 is a relay which causes the power line 110 and the power line 113 to conduct when both the control unit 202 in the charge/discharge apparatus 200 and the control unit 102 in the electric vehicle 100 permit charge/discharge.

Specifically, when the power line 110 is set to “H” and the power line 113 is set to “L”, the relay inside the conductor 103 operates. When a connection permission signal permitting connection of the charge/discharge apparatus 200 to the electric vehicle 100 is supplied from the outside, a voltage is applied to the signal lines 211 and 111, the coil in the conductor 103 is excited, and a plunger inside the conductor 103 is sucked. As a result, the power lines 113 and 110 are caused to conduct, and power stored in the charge/discharge apparatus 200 can be discharged and charged to the power supply source 101.

The power supply source 101 is connected to the inlet 104 via the power line 110, the conductor 103, and the power line 113. During discharge, power stored in the power supply source 101 is supplied to the power conversion unit 201 in the charge/discharge apparatus 200 via the power line 110, the conductor 103, the power line 113, the inlet 104, the charge/discharge connector 204, and the power line 210. During charge, direct-current power output from the power conversion unit 201 is supplied to the power supply source 101 via the power line 210, the charge/discharge connector 204, the inlet 104, the power line 113, the conductor 103, and the power line 110.

As a type of the power supply source 101, a nickel-metal hydride storage battery, a lithium ion storage battery, or a lithium ion polymer storage battery can be exemplified. The types of the power supply source 101 are not limited thereto, and any secondary battery chargeable by the charge/discharge apparatus 200 may be used. The power supply source 101 is used for the following applications.

(1) The power supply source 101 mounted on a motor vehicle that includes an internal combustion engine, stores power generated by an alternator driven by the internal combustion engine, and can be used also as a temporary power supply source to the load 30 when capacity thereof is relatively large.

(2) The power supply source 101 mounted on a plug-in hybrid vehicle or a hybrid vehicle supplies power to a traction motor or stores power regenerated by the motor, and can be used also as a power supply source to the load 30.

(3) The power supply source 101 mounted on the electric vehicle 100 supplies power to the traction motor or stores power regenerated by the motor, and can be used also as a power supply source to the load 30.

The control unit 102 has a communication function of transmitting and receiving various types of information to and from the control unit 202 in the charge/discharge apparatus 200 via the communication line 112.

The power conversion unit 201 is a bidirectional power conversion unit having a Direct Current to Alternating Current (DC-AC) conversion function and an Alternating Current to Direct Current (AC-DC) conversion function. When the load 30 is operated with the power stored in the power supply source 101, the power conversion unit 201 operates as a DC-AC converter, converts direct-current power supplied from the power supply source 101 into alternating-current power, and outputs the alternating-current power. When the power supply source 101 is charged with power supplied from the power system 10, the power conversion unit 201 operates as an AC-DC converter, converts alternating-current power supplied from the power system 10 into direct-current power, and outputs the direct-current power.

The control unit 202 controls the operation of the power conversion unit 201 and has a function of sensing abnormalities such as overcurrent and overvoltage by monitoring a current and a voltage of a charge/discharge path using a measurement device (not illustrated). The control unit 202 also has functions of various types of communication performed between the control unit 102 and the control unit 202 via the communication lines 112 and 212. The control unit 202 performs control to close the conductor 103 and the interconnection switch 203 in order to connect the distribution board 20 and the power supply source 101 at the time of charging/discharging.

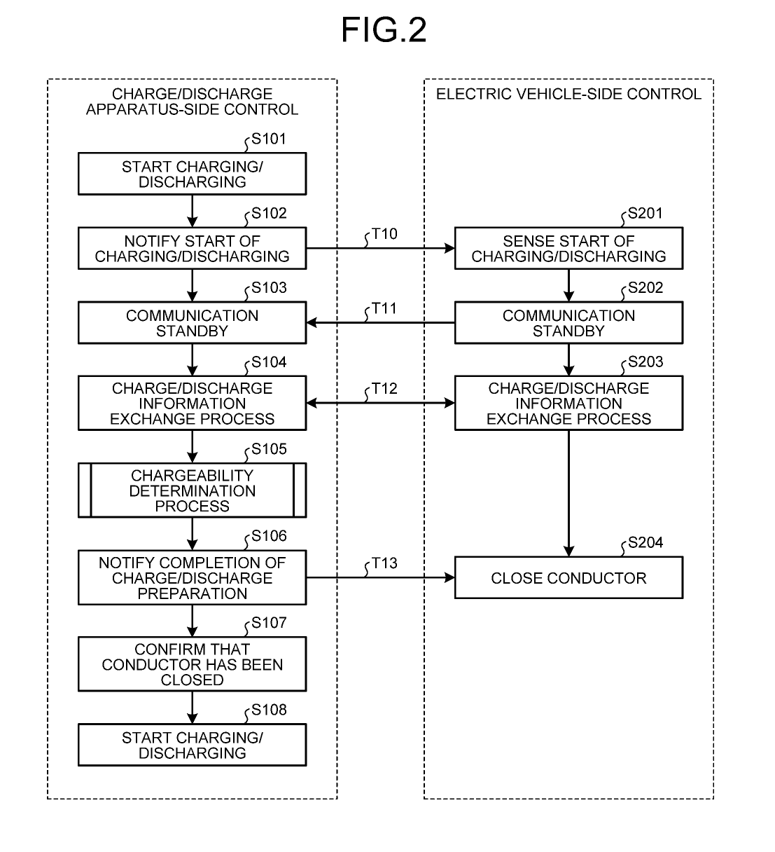

FIG. 2 is a sequence chart illustrating operations of the charge/discharge apparatus according to the embodiment of the present invention and an electric vehicle.

In S101, the control unit 202 of the charge/discharge apparatus 200 starts a charge/discharge start sequence. For example, a charge/discharge start command output from a controller (not illustrated) is input to the charge/discharge apparatus 200, thereby the charge/discharge start sequence is started.

In S102, the control unit 202 outputs a charge/discharge start signal T10 in order to notify the electric vehicle 100 of the start of charging/discharging. The charge/discharge start signal T10 is received by the control unit 102 via the communication lines 112 and 212. The control unit 202, which has output the charge/discharge start signal T10, transits to a communication standby state with respect to the electric vehicle 100 and the charge/discharge apparatus 200 in S103.

Upon receiving the charge/discharge start signal T10 in S201, the control unit 102 detects the start of charging/discharging. The control unit 102, which has detected the start of charging/discharging, transits to a communication standby state in the electric vehicle 100 and the charge/discharge apparatus 200 in S202, and outputs a communication preparation completion signal T11. The communication preparation completion signal T11 is received by the control unit 102 via the communication lines 112 and 212.

The control unit 102, which has transited to the communication standby state, and the control unit 202, which has received the communication preparation completion signal T11, perform an exchange process of charge/discharge information T12 in S104 and S203, respectively, via the communication lines 112 and 212.

For example, the charge/discharge information T12 from the electric vehicle 100 may include a remaining power amount, an upper limit value of a charge/discharge current, and upper and lower limit values of a charge/discharge voltage, which are pieces of information on the power supply source 101. Furthermore, the charge/discharge information T12 from the charge/discharge apparatus 200 may include a value of a voltage capable of being input/output and a value of a current capable of being input/output, which are pieces of information on the power conversion unit 201.

In S105, the control unit 202 performs a chargeability determination process using the information on the power supply source 101 obtained in the charge/discharge information exchange process in S104. Details of the chargeability determination process will be described later.

When the control unit 202 has determined in S105 that charging/discharging is possible, the control unit 202 transmits a charge/discharge preparation completion signal T13 to the control unit 102 in S106. The control unit 102, which has received the charge/discharge preparation completion signal T13, closes the conductor 103 in S204.

After the control unit 202 confirms in S107 that the conductor 103 has been closed, the control unit 202 controls the power conversion unit 201 in S108, thereby starting a charge/discharge operation. That is, the control unit 202 causes the power conversion unit 201 to perform an AC-DC conversion operation or a DC-AC conversion operation.

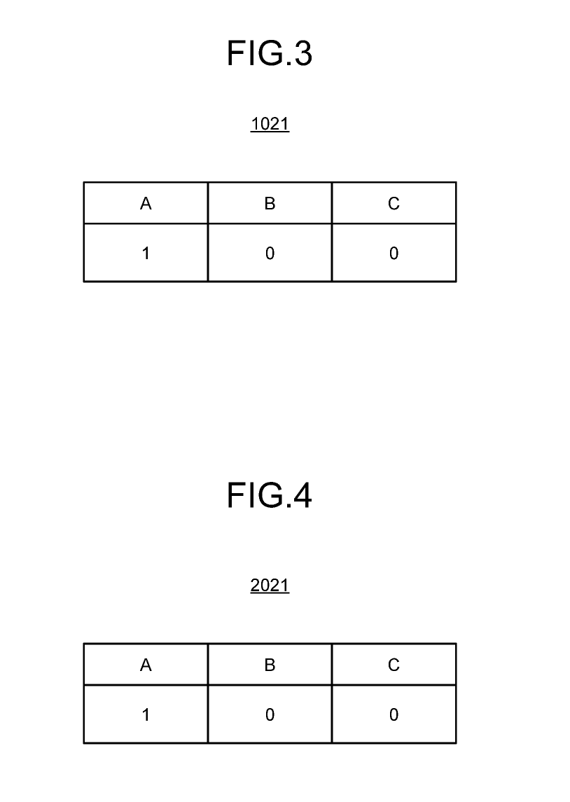

FIG. 3 is a diagram illustrating an example of a battery identification table that is set in the control unit in the electric vehicle illustrated in FIG. 1.

In the battery identification table 1021 illustrated in FIG. 3, a type of one or a plurality of secondary batteries mounted on the electric vehicle 100 and identification information correspondingly identifying the presence or absence of each of the one or a plurality of secondary batteries are associated with each other. In FIG. 3, three types of secondary batteries A, B, and C, and information indicating the presence or absence of each of the three types of secondary batteries A, B, and C are correspondingly associated with each other. For example, the secondary battery A is a nickel-metal hydride storage battery, the secondary battery B is a lithium ion storage battery, and the secondary battery C is a lithium ion polymer storage battery.

“1” indicates that a corresponding secondary battery is mounted on the electric vehicle 100 that includes the battery identification table 1021. “0” indicates that a corresponding secondary battery is not mounted on the electric vehicle 100 that includes the battery identification table 1021.

The battery identification table 1021 is stored in a storage unit (not illustrated) constituting the control unit 102. Information on the battery identification table 1021 included in the control unit 102 is transmitted to the control unit 202 via the communication lines 112 and 212 in S104 illustrated in FIG. 2, for example.

In FIG. 3, information on three secondary batteries A, B, and C is recorded in the battery identification table 1021; however, identification information on storage batteries other than these secondary batteries may be recorded in the battery identification table 1021. In the battery identification table 1021, instead of the identification information on the multiple secondary batteries A, B, and C, identification information on one secondary battery may be recorded.

FIG. 4 is a diagram illustrating an example of a charging method compatibility table that is set in the control unit in the charge/discharge apparatus illustrated in FIG. 1. In the charging method compatibility table 2021 illustrated in FIG. 4, a type of one or a plurality of secondary batteries mounted on the electric vehicle 100, and either one of compatibility information “1” and non-compatibility information “0”, are correspondingly associated with each other. The compatibility information “1” indicates that the charge/discharge apparatus 200 is compatible with a charging method in accordance with characteristics of each of the one or a plurality of secondary batteries mounted on the electric vehicle 100. The non-compatibility information “0” indicates that the charge/discharge apparatus 200 is not compatible with the charging method.

The charging method compatibility table 2021 is stored in a storage unit (not illustrated) constituting the control unit 202. Information on the charging method compatibility table 2021 included in the control unit 202 is transmitted to the control unit 102 via the communication lines 112 and 212 in S104 illustrated in FIG. 2, for example.

In FIG. 4, compatibility information or non-compatibility information is recorded for each of the three secondary batteries A, B, and C in the charging method compatibility table 2021; however, compatibility information or non-compatibility information for each of storage batteries other than these secondary batteries may be recorded in the charging method compatibility table 2021. In the charging method compatibility table 2021, instead of the compatibility information or the non-compatibility information for each of the multiple secondary batteries A, B, and C, compatibility information or non-compatibility information on one secondary battery may be recorded.

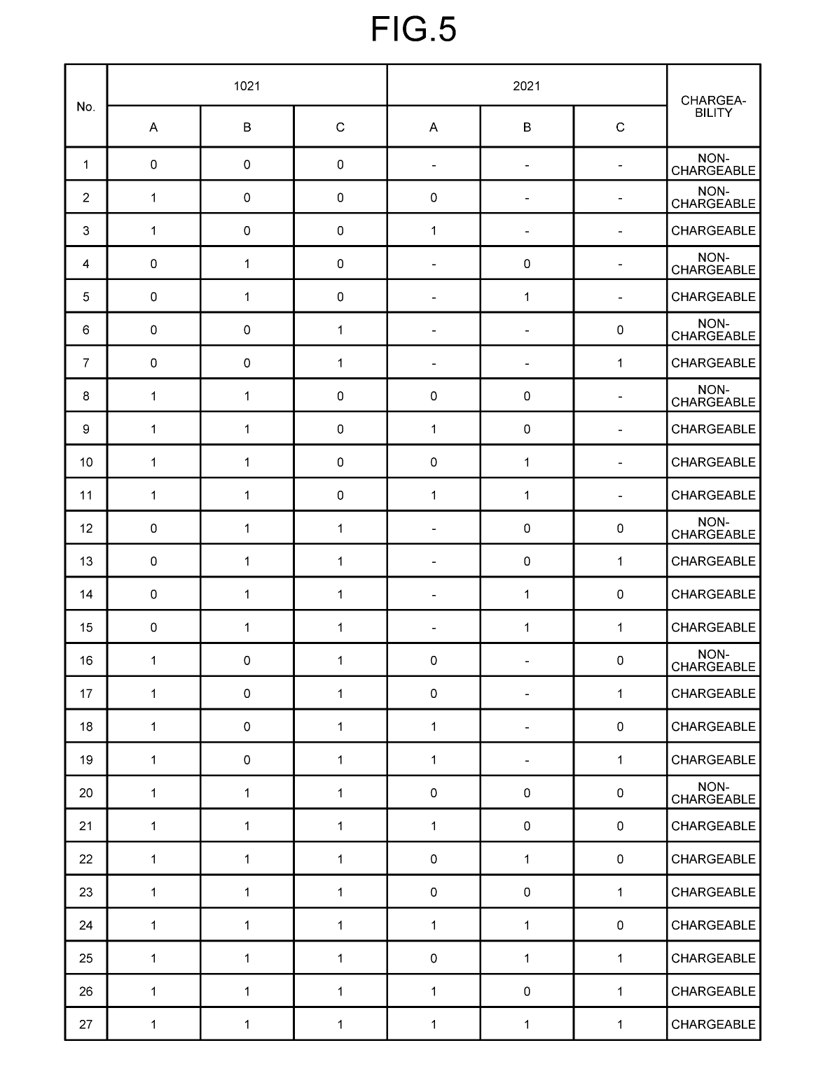

FIG. 5 is a diagram for explaining a process for determining chargeability based on the battery identification table illustrated in FIG. 3 and the charging method compatibility table illustrated in FIG. 4. FIG. 5 illustrates, as an example, information on three secondary batteries A, B, and C recorded in each of the 27 types of battery identification tables 1021 and information on the charging method compatibility tables 2021. “−” means that either chargeability information “1” or non-chargeability information “0” may be applied.

For example, information corresponding to the secondary batteries A, B, and C indicated in the row of No. 1 includes information in the battery identification table 1021 included in a first motor vehicle among the multiple electric vehicles 100, and information in the charging method compatibility table 2021 included in the charge/discharge apparatus 200 connected to the first motor vehicle.

Similarly, information corresponding to the secondary batteries A, B, and C indicated in the row of No. 2 includes information in the battery identification table 1021 included in a second motor vehicle that is different from the first motor vehicle among the multiple electric vehicles 100, and information in the charging method compatibility table 2021 included in the charge/discharge apparatus 200 connected to the second motor vehicle.

The chargeability is determined as follows. When logical AND of pieces of information corresponding to secondary batteries of the same type, among the information on the secondary batteries indicated in the battery identification table 1021 and the information on the secondary batteries indicated in the charging method compatibility table 2021, is “1”, it is determined that “charging is possible”, and when logical AND of pieces of information corresponding to secondary batteries of the same type is “0”, it is determined that “charging is impossible”.

A method for determining chargeability will be described with the information indicated in the row of No. 3 as an example. When information on the secondary battery A in the battery identification table 1021 is “1” and information on the secondary battery A in the charging method compatibility table 2021 that is included in the charge/discharge apparatus 200, which is connected to the electric vehicle 100 that includes the battery identification table 1021, is “1”, the charge/discharge apparatus 200 is compatible with a charging method in accordance with the characteristics of the power supply source 101 mounted on the electric vehicle 100, and therefore it is determined that charging is possible.

The method for determining chargeability will be described with the information indicated in the row of No. 4 as another example. When information on the secondary battery B in the battery identification table 1021 is “1” and information on the secondary battery B in the charging method compatibility table 2021 included in the charge/discharge apparatus 200, which is connected to the electric vehicle 100 including the battery identification table 1021, is “0”, the charge/discharge apparatus 200 is not compatible with a charging method in accordance with the characteristics of the power supply source 101 mounted on the electric vehicle 100, and therefore it is determined that charging is impossible.

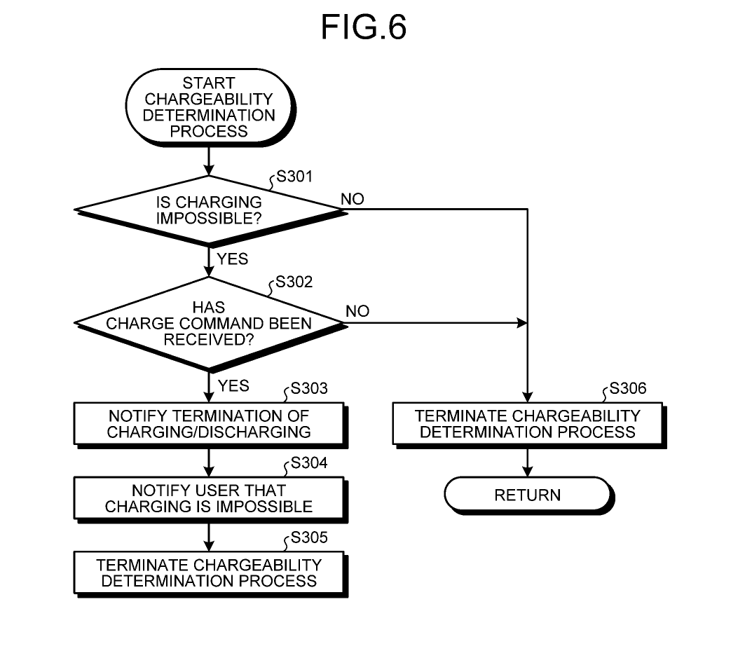

FIG. 6 is a flowchart of the chargeability determination process in S105 illustrated in FIG. 2. When the chargeability determination process is started in S105 of FIG. 2, the control unit 202 determines chargeability in S301 of FIG. 6 based on a chargeability compatibility table illustrated in FIG. 5. In a case where it is determined that charging is impossible (S301, Yes), the control unit 202 determines in S302 whether a charge command has been received. The charge command indicates start of charging and is output from a controller (not illustrated) which controls the charge/discharge apparatus 200. In a case where the charge command has been received (S302, Yes), the power supply source 101 cannot be charged, so the control unit 202 notifies the control unit 102 of termination of charging/discharging in S303, and terminates charge/discharge control on the electric vehicle side.

In order to notify a user that the power supply source 101, which cannot be charged, is mounted on the electric vehicle 100 connected to the charge/discharge apparatus 200, the control unit 202 generates message information indicating, for example, “this charge/discharge apparatus cannot charge the electric vehicle currently connected” in S304. The message information is transmitted to a controller (not illustrated) which controls the charge/discharge apparatus 200, and the controller, which has received the message information, displays the above message as textual information on a display screen provided in the controller.

The control unit 202, which has completed the notification to the user in S304, terminates the chargeability determination process in S305.

In a case where it is determined in S301 that charging is possible (S301, No), the control unit 202 terminates the chargeability determination process in S306 and performs the processes in S106 and subsequent steps in FIG. 2.

In a case where the charge command has not been received in S302 (S302, No), the control unit 202 terminates the chargeability determination process in S306 and performs the processes in S106 and subsequent steps in FIG. 2.

As described above, the charge/discharge apparatus 200 according to the present embodiment is configured to determine chargeability to the secondary battery in the electric vehicle 100, which is a motor vehicle connected to the charge/discharge apparatus 200, using compatibility information indicating that the charge/discharge apparatus 200 is compatible with the charging method in accordance with the characteristics of the power supply source 101, which is a secondary battery, and non-compatibility information indicating that the charge/discharge apparatus 200 is not compatible with the charging method. As a result, it is possible to prevent charging of the power supply source 101, which is not compatible with the charging method in accordance with the characteristics of the power supply source 101, and to reduce performance deterioration of the power supply source 101 or the charge/discharge apparatus 200. In addition, by performing the chargeability determination process before closing of the conductor 103, it is possible to prevent the power stored in the power supply source 101 from being output to the outside.

In the above, the example has been described in which the power supply source 101 mounted on the electric vehicle 100 is a secondary battery such as a nickel-metal hydride storage battery, a lithium ion storage battery, or a lithium ion polymer storage battery. However, other than the secondary battery, power sources such as an internal combustion engine or a fuel cell may be mounted on a motor vehicle. Even when connected to a motor vehicle equipped with at least one of these power sources, the charge/discharge apparatus 200 according to the present embodiment can also determine chargeability to the power source mounted on the motor vehicle. Specific examples will be described below.

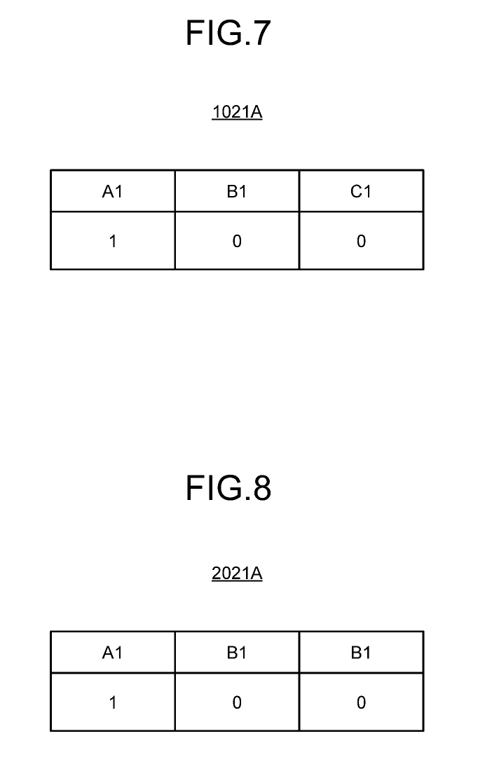

FIG. 7 is a diagram illustrating an example of a power source identification table set in a control unit of a motor vehicle equipped with a power source such as a secondary battery, an internal combustion engine, or a fuel cell, instead of the electric vehicle illustrated in FIG. 1.

In the power source identification table 1021A illustrated in FIG. 7, types of power sources mounted on the motor vehicle and identification information identifying the presence or absence of the power sources are associated with each other. In FIG. 7, three types of power sources and information each indicating the presence or absence of the three types of power sources are associated with each other. For example, A1 indicates a secondary battery, B1 indicates an internal combustion engine, and C1 indicates a fuel cell. However, the power sources exemplified here are only an example, and there is no limitation thereto. “1” indicates that a corresponding power source is mounted on a motor vehicle including the power source identification table 1021A. “0” indicates that a corresponding power source is not mounted on a motor vehicle including the power source identification table 1021A. The power source identification table 1021A is stored in a storage unit (not illustrated) included in the control unit 102. Information on the power source identification table 1021A included in the control unit 102 is transmitted to the control unit 202 via the communication lines 112 and 212 in S104 illustrated in FIG. 2, for example.

FIG. 8 is a diagram illustrating a modification of the charging method compatibility table set in the control unit in the charge/discharge apparatus illustrated in FIG. 1. In the charging method compatibility table 2021A illustrated in FIG. 8, types of power sources mounted on a motor vehicle, and chargeability information “1” or non-chargeability information “0” for each of the types of power sources are associated with each other. The chargeability information “1” indicates that the power source mounted on the motor vehicle is chargeable. The non-chargeability information “0” indicates that the power source is not chargeable. The charging method compatibility table 2021A is stored in a storage unit (not illustrated) included in the control unit 202. Information on the charging method compatibility table 2021A included in the control unit 202 is transmitted to the control unit 102 via the communication lines 112 and 212 in S104 illustrated in FIG. 2, for example.

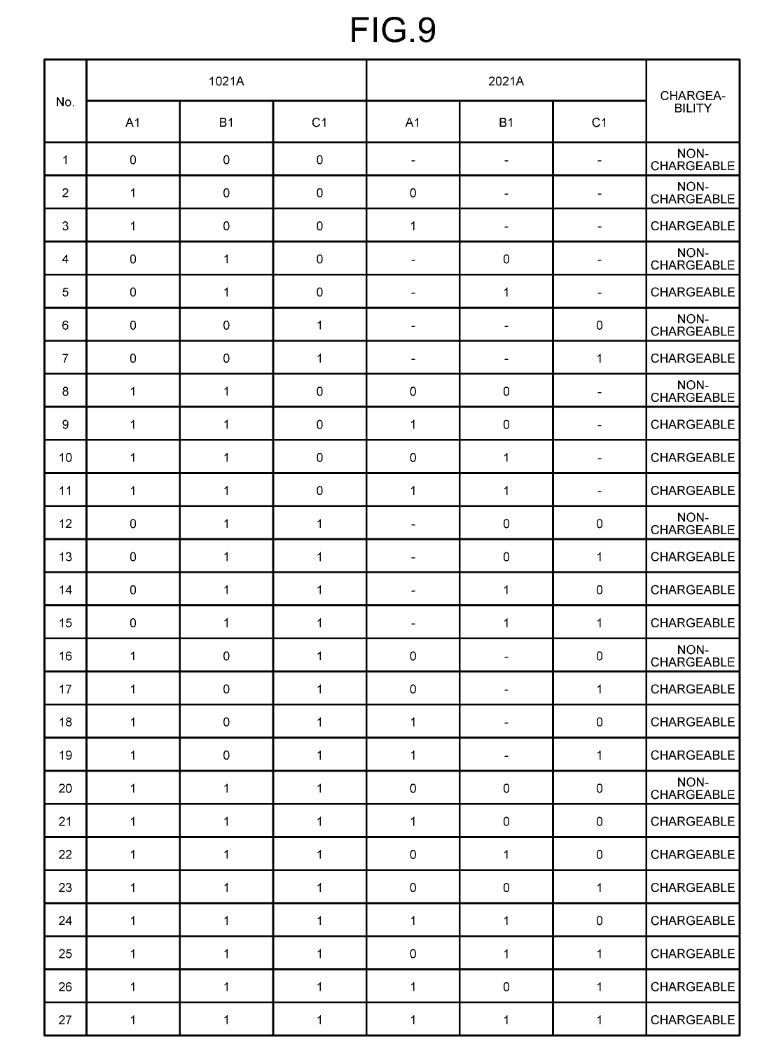

FIG. 9 is a diagram for explaining a process of determining chargeability based on the power source identification table illustrated in FIG. 7 and the charging method compatibility table illustrated in FIG. 8. FIG. 5 illustrates, as an example, information on three power sources A1, B1, and C1 recorded in each of the 27 types of power source identification tables 1021A and information in the charging method compatibility tables 2021A. “−” means that either chargeability information “1” or non-chargeability information “0” may be applied.

The chargeability is determined as follows. When logical AND of pieces of information corresponding to power sources of the same type, among the information on the power sources indicated in the power source identification table 1021A and the information on the power sources indicated in the charging method compatibility table 2021A, is “1”, it is determined that “charging is possible”, and when logical AND of pieces of information corresponding to power sources of the same type is “0”, it is determined that “charging is impossible”. “−” means that either chargeability information “1” or non-chargeability information “0” may be applied.

A method for determining chargeability will be described with the information indicated in the row of No. 3 as an example. Here, the description will be given assuming that the power source A1 is a secondary battery. When the information on the power source A1 in the power source identification table 1021A is “1” and the information on the power source A1 in the charging method compatibility table 2021A included in the charge/discharge apparatus 200, which is connected to a motor vehicle including the power source identification table 1021A, is “1”, the charge/discharge apparatus 200 determines that charging to the secondary battery mounted on the motor vehicle is possible.

The method for determining chargeability will be described with the information indicated in the row of No. 4 as other example. Here, the description will be given assuming that the power source B1 is a fuel cell. When the information on the power source B1 in the power source identification table 1021A is “1” and the information on the power source B1 in the charging method compatibility table 2021A included in the charge/discharge apparatus 200, which is connected to a motor vehicle including the power source identification table 1021A, is “0”, the charge/discharge apparatus 200 determines that charging to the fuel cell mounted on the motor vehicle is impossible.

The method for determining chargeability will be described with the information indicated in the row of No. 12 as another example. Here, the description will be given assuming that the power source A1 is a nickel-metal hydride secondary battery and the power source C1 is a lithium ion secondary battery. When the information on each of the power sources A1 and C1 in the power source identification table 1021A is “1” and the information on each of the power sources A1 and C1 in the charging method compatibility table 2021A included in the charge/discharge apparatus 200, which is connected to a motor vehicle including the power source identification table 1021A, is “1”, the charge/discharge apparatus 200 determines that the nickel-metal hydride secondary battery and the lithium ion secondary battery are mounted on the motor vehicle and determines that charging to the secondary batteries is possible.

The control unit 202 performs the processes illustrated in FIGS. 2 and 6 by using the tables illustrated in FIGS. 7 and 8, and determines chargeability. For example, a fuel cell vehicle can supply power generated by chemical reactions of hydrogen to a household appliance, but cannot be charged. In a case where the user mistakenly performs a charging operation and a charge command is output when the charge/discharge apparatus 200 is connected to the fuel cell vehicle, the charge/discharge apparatus 200 determines that charging is impossible because the charge/discharge apparatus 200 is not compatible with charging of the fuel cell. As a result, safety of the charge/discharge apparatus 200 and the fuel cell vehicle is maintained.

The configuration described in the embodiment above indicates one example of the content of the present invention and can be combined with other known technology, and a part thereof can be omitted or modified without departing from the gist of the present invention.

### REFERENCE SIGNS LIST

10 power system; 20 distribution board; 30 load; 100 electric vehicle; 101 power supply source; 102, 202 control unit; 103 conductor; 104 inlet; 110, 113, 210 power line; 111, 211 signal line; 112, 212 communication line; 200 charge/discharge apparatus; 201 power conversion unit; 203 interconnection switch; 204 charge/discharge connector; 300 charge/discharge system; 1021 battery identification table; 1021A power source identification table; 2021, 2021A charging method compatibility table.

1. A charge/discharge apparatus comprising a power converter to convert alternating-current power into direct-current power and to supply the direct-current power to a secondary battery in a motor vehicle and a controller to control the power converter and to perform transmission of information between the motor vehicle and the controller, wherein
the motor vehicle includes a battery identification table in which a type of the secondary battery and identification information identifying presence or absence of the secondary battery are associated with each other, and
the controller includes a charging method compatibility table in which the type of the secondary battery, and compatibility information indicating that the charge/discharge apparatus is compatible with a charging method in accordance with characteristics of the secondary battery or non-compatibility information indicating that the charge/discharge apparatus is not compatible with the charging method, are associated with each other, and determines chargeability to the secondary battery in the motor vehicle connected to the charge/discharge apparatus using the battery identification table and the charging method compatibility table.

2. (canceled)

3. The charge/discharge apparatus according to claim 1, wherein the controller determines that charging is impossible when logical AND of pieces of information corresponding to a secondary battery of a same type, among information on the secondary battery indicated in the battery identification table and information on the secondary battery indicated in the charging method compatibility table, is 0, and notifies the motor vehicle of termination of charging/discharging.

4. The charge/discharge apparatus according to claim 3, wherein when determining that charging is impossible, the controller generates information notifying that a secondary battery that is not chargeable by the charge/discharge apparatus is mounted on the motor vehicle that is connected to the charge/discharge apparatus.

5. (canceled)
